(19) United States
(12) Patent Application Publication
(10) Pub. No.: US 2026/0229112 A1
(43) Pub. Date: Aug. 6, 2026

(54) LOW-FREQUENCY MESH NETWORK FOR VEHICLE TELEMATICS DATA TRANSMISSION

(71) Applicant: State Farm Mutual Automobile Insurance Company, Bloomington, IL (US)

(72) Inventors: Michael Best, Mesa, AZ (US); Chad Witt, Bloomington, IL (US)

(73) Assignee: State Farm Mutual Automobile Insurance Company, Bloomington, IL (US)

(21) Appl. No.: 19/044,306

(22) Filed: Feb. 3, 2025

(51) Int. Cl. G08C 17/02

(52) U.S. Cl. CPC G08C 17/02

(57) ABSTRACT

A system may include one or more processors, and one or more non-transitory, computer-readable media including instructions which, when executed by the one or more processors, cause the one or more processors to receive, via a first communication protocol, from a first sensor device, a first data packet including vehicle telematics data associated with a vehicle, the vehicle telematics data captured using one or more sensors of a second sensor device coupled to the vehicle, wherein the first sensor device received the vehicle telematics data from the second sensor device via a second communication protocol, generate a second data packet including the vehicle telematics data and an identifier of the second sensor device, and transmit the second data packet via a third communication protocol to an external computing system.

### TECHNICAL FIELD

The present disclosure generally relates to transmitting vehicle telematics data using a low-frequency mesh network of devices.

### BACKGROUND

Vehicle telematics data can be transmitted using a telecommunications network, such as a cellular network. A sensor device can capture vehicle telematics data and transmit the vehicle telematics data to a mobile device, which transmits the vehicle telematics data via a cellular connection to an external computing system. However, if communication between the sensor data and the mobile device, or between the mobile device and the external computing system, is interrupted, the vehicle telematics data may not reach the external computing system.

### BRIEF SUMMARY

Aspects of the present disclosure are directed to a system, including one or more processors, and one or more non-transitory, computer-readable media including instructions which, when executed by the one or more processors, cause the one or more processors to receive, via a first communication protocol, from a first sensor device, a first data packet including vehicle telematics data associated with a vehicle, the vehicle telematics data captured using one or more sensors of a second sensor device coupled to the vehicle, wherein the first sensor device received the vehicle telematics data from the second sensor device via a second communication protocol, generate a second data packet including the vehicle telematics data and an identifier of the second sensor device, and transmit the second data packet via a third communication protocol to an external computing system.

In some implementations, the first sensor device includes a housing enclosing one or more accelerometers, wherein the housing is separate from and structured to be coupled to a vehicle. In some implementations, the first sensor device is substantially identical to the second sensor device, and wherein the first sensor device is structured to be coupled to a vehicle. In some implementations, the second communication protocol uses a frequency less than 1 GHz. In some implementations, the second communication protocol includes a long range wide area network protocol. In some implementations, the system includes the external computing system, wherein the external computing system executes instructions to associate, in a database, the vehicle telematics data with the vehicle. In some implementations, the system includes the external computing system, wherein the external computing system determines, using the vehicle telematics data associated with the vehicle, a vehicle condition of a plurality of predefined vehicle conditions. In some implementations, the first sensor device received the vehicle telematics data from the second sensor device via a third sensor device.

Aspects of the present disclosure are directed to a method including receiving, by a mobile device, from a first sensor device, via a first communication protocol, a first data packet including vehicle telematics data associated with a vehicle, the vehicle telematics data captured using one or more sensors of a second sensor device coupled to the vehicle, wherein the first sensor device received the vehicle telematics data from the second sensor device via a second communication protocol, generating, by the mobile device, a second data packet including the vehicle telematics data and an identifier of the second sensor device, and transmitting, by the mobile device, the second data packet via a third communication protocol to an external computing system.

In some implementations, the first sensor device includes a housing enclosing one or more accelerometers, wherein the housing is separate from and structured to be coupled to a vehicle. In some implementations, the first sensor device is substantially identical to the second sensor device, and the first sensor device is structured to be coupled to a vehicle. In some implementations, the first and second sensor devices are identical and are each structured to be coupled to a vehicle. In some implementations, the second communication protocol uses a frequency less than 1 GHz. In some implementations, the second communication protocol includes a long range wide area network protocol. In some implementations, the method includes associating in a database, by the external computing system, the vehicle telematics data with the vehicle. In some implementations, the method includes determining, by the external computing system, using the vehicle telematics data associated with the vehicle, a vehicle condition of a plurality of predefined vehicle conditions. In some implementations, the first sensor device received the vehicle telematics data from the second sensor device via a third sensor device.

Aspects of the present disclosure are directed to a method including determining, by a first sensor device coupled to a vehicle, that a first data packet transmitted via a first communication protocol failed to be delivered to a first mobile device, wherein the first data packet includes vehicle telematics data associated with the vehicle, in response to the failure of the first data packet to be delivered to the first mobile device via the first communication protocol, generating, by the first sensor device, a second data packet including the vehicle telematics data associated with the vehicle, and transmitting, by the first sensor device, via a second communication protocol, the second data packet to a second sensor device, the second sensor device configured to transmit data packets to a second mobile device via the first communication protocol.

In some implementations, determining, by the first sensor device, that the first data packet transmitted via a first communication protocol failed to be delivered to the first mobile device includes determining that a predetermined amount of time has elapsed since attempted transmission of the data packet without receiving an acknowledgement from the first mobile device. In some implementations, the first mobile device and the second mobile device include instructions to transmit data to an external computing system via a third communication protocol. In some implementations, the second communication protocol uses a frequency less than 1 GHz.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers indicate identical, functionally similar, and/or structurally similar elements.

FIG. 1 illustrates an example telematics system including a low-frequency mesh network for vehicle telematics data transmission.

FIG. 2 illustrates details of the first sensor device of FIG. 1.

FIG. 3 is a flow chart illustrating operations of an example method for transmitting vehicle telematics data via a low-frequency mesh network.

FIG. 4 is a flow chart illustrating operations of an example method for transmitting vehicle telematics data via a low-frequency mesh network.

The Figures depict preferred embodiments for purposes of illustration only. One skilled in the art will readily recognize from the following discussion that alternative embodiments of the systems and methods illustrated herein may be employed without departing from the principles of the present embodiments described herein.

### DETAILED DESCRIPTION

Embodiments and implementations discussed herein relate to systems and methods for using a long-range, low-frequency mesh network to transmit vehicle telematics data. Conventional systems for transmitting vehicle telematics data include collecting vehicle telematics data using a sensor device, transmitting the vehicle telematics data from the sensor device to a mobile device, and transmitting the vehicle telematics data from the mobile device to an external computing system for analysis. However, if a connection between the sensor device and the mobile device, or a connection between the mobile device and the external computing system, is interrupted, the vehicle telematics data may not reach the external computing system. Thus, malfunction, misconfiguration, or lack of cellular connection of the mobile device can prevent the vehicle telematics data from being transmitted to the external computing system.

Embodiments and implementations described herein provide for a long-range, low-frequency mesh network between sensor devices for transmitting vehicle telematics data. The mesh network can function as a backup to data streams where each sensor device sends data to a corresponding mobile device which sends data to the external computing system. The mesh network can allow sensor devices to pass vehicle telematics data to other sensor devices in the mesh network until a connection to the external computing system via a mobile device is found. In this way, the sensor devices can form a mesh network allowing for greater reliability of transmission of the vehicle telematics data. In some implementations, embodiments disclosed herein may allow for transmission of vehicle telematics data in situations where a mobile device is in an area without coverage from a cellular network (e.g., without coverage from a driver's cellular network or without any cellular network coverage), such as a rural environment, by passing communications via the long-range, low-frequency mesh network until they reach a vehicle connected to a mobile device that does have such coverage (or reach a vehicle that itself has such coverage, such as a vehicle with an integrated cellular transceiver).

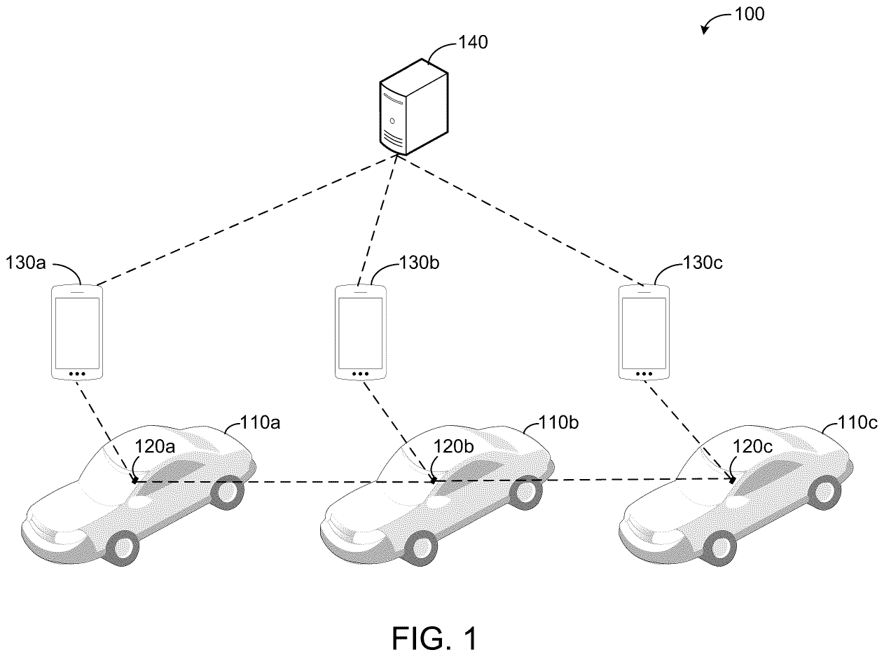

FIG. 1 illustrates an example telematics system 100 including a low-frequency mesh network for vehicle telematics data transmission. The system 100 includes a first vehicle 110a, a second vehicle 110b, a third vehicle 110c (referred to collectively herein as vehicles 110), a first sensor device 120a, a second sensor device 120b, a third sensor device 120c (referred to collectively herein as sensor devices 120), a first mobile device 130a, a second mobile device 130b, a third mobile device 130c (referred to collectively herein as mobile devices 130), and an external computing system 140 (e.g., server, computing cluster, etc.). The sensor devices 120 and the mobile devices 130 can transmit vehicle telematics data of the vehicles 110 to the external computing system 140 to detect vehicle conditions of the vehicles 110. In some implementations, the sensor devices 120 are substantially identical and/or interchangeable. The sensor devices 120 are structured to be coupled to the vehicles 110.

The sensor devices 120 are each coupled to a corresponding vehicle of the vehicles 110. The first sensor device 120a is coupled to the first vehicle 110a, the second sensor device 120b is coupled to the second vehicle 110b, and the third sensor device 120c is coupled to the third vehicle 110c. While the sensor devices 120 are illustrated as including three sensor devices coupled to three corresponding vehicles of the vehicles 110, the sensor devices 120 can include any number of sensor devices coupled to a corresponding number of vehicles. The sensor devices 120 can be coupled to the vehicles 110 in such a way as to capture vehicle telematics data of the vehicles 110. In an example, the first sensor device 120a is coupled to an interior surface of a windshield of the first vehicle 110a in order to capture vehicle telematics data (e.g., acceleration data, location data, vibration data, use data, etc.) of the first vehicle 110a.

The sensor devices 120 each include one or more sensors that capture vehicle telematics data (e.g., time series sensor data), including acceleration data. The sensor devices 120 can each include one or more accelerometers to capture acceleration data in three dimensions. In an example, the sensor devices 120 each include three accelerometers capturing acceleration data along three axes. In an example, the sensor devices 120 each include a multi-axis accelerometer capturing acceleration data along three axes. The sensor devices 120 can be coupled to the vehicles 110 to capture vehicle telematics data (e.g., acceleration data) of the vehicles 110. In an example, the first sensor device 120a is coupled to an interior surface of a windshield of the first vehicle 110a.

The sensor devices 120 each include an antenna for communicating with corresponding mobile devices 130 using a first communication protocol. The first communication protocol can be a short-range wireless communication protocol with a range of about ten meters. The first communication protocol can use ultra-high frequency radio waves, such as radio waves in the industrial, scientific, and medical (ISM) band from 2.402 GHz to 2.48 GHz. The first communication protocol can have a data rate of 1-3 Mb/s. In an example, the first communication protocol is BLUETOOTH. The sensor devices 120 can each transmit data (e.g., telematics data, acceleration data, etc.) to a paired mobile device of the mobile devices 130. In an example, a first user pairs the first mobile device 130a with the first sensor device 120a such that the first mobile device 130a receives vehicle telematics of the first vehicle 110a captured by the first sensor device 120a. In this example, an application running on the first mobile device 130a causes the first mobile device 130a to transmit the vehicle telematics of the first vehicle 110a to the external computing system 140.

The sensor devices 120 each include an antenna for communicating among the sensor devices 120 using a second communication protocol. In some implementations, the antenna for the first communication protocol is the same as the antenna for the second communication protocol. In some implementations, the sensor devices 120 each include separate antennae for the first communication protocol and the second communication protocol. The second communication protocol can be a long range radio communication protocol. The second communication protocol can have a longer range than the first communication protocol with a range of about 6.2 miles, or at least 1 mile. In an example, the second communication protocol can have a range of over 6.2 miles in rural areas and a range of about 1.8 miles in urban areas. The second communication protocol can use sub-gigahertz radio waves. The second communication protocol can use a lower data rate than the first communication protocol of about 0.3-50 kbit/s. The second communication protocol can use less power than the first communication protocol. In an example, the second communication protocol is a long range wide area network (LORAWAN) communication protocol. The sensor devices 120 can transmit data among themselves using the second communication protocol. The sensor devices 120 can form a low-frequency mesh network. In an example, the sensor devices 120 can form a LORAWAN network.

In some implementations, the sensor devices 120 each transmit data to their corresponding mobile device of the mobile devices 130 using the first communication protocol (e.g., BLUETOOTH) when the first communication protocol is available (e.g., data is successfully transmitted using the first communication protocol. When the first communication protocol is unavailable, the sensor devices 120 can transmit data (i.e., telematics data) among themselves via the low-frequency mesh network using the second communication protocol. The data can be transmitted through the low-frequency mesh network until the data reaches a sensor device of the sensor devices 120 that has a connection to its corresponding mobile device of the mobile devices 130, which is used to transmit the data to the corresponding mobile device for transmission to the external computing system 140. In this way, the low-frequency mesh network, leveraging the second communication protocol, can function as a backup to the first communication protocol.

In an example, the first sensor device 120a does not have a connection with the first mobile device 130a. In this example, the first sensor device 120a at one point had a connection with the first mobile device 130a, but the connection was lost due to a malfunction of the first mobile device 130a, loss of power of the first mobile device 130a, configuration of the first mobile device 130a (e.g., BLUETOOTH is turned off), or another reason. In this example, the first sensor device 120a, in response to the connection with the first mobile device 130a via the first communication protocol being unavailable, transmits vehicle telematics data of the first vehicle 110a via the second communication protocol to the second sensor device 120b. If the second sensor device 120b has a connection with the second mobile device 130b, the second sensor device 120b transmits the vehicle telematics data of the first vehicle 110a to the second mobile device 130b using the first communication protocol so the second mobile device 130b can transmit the vehicle telematics data of the first vehicle 110a to the external computing system 140. If the second sensor device 120b does not have a connection with the second mobile device 130b, the second sensor device 120b transmits the acceleration data of the first vehicle 110a to the third sensor device 120c using the second communication protocol and the third sensor device 120c transmits the vehicle telematics data of the first vehicle 110a to the third mobile device 130c using the first communication protocol so the third mobile device 130c can transmit the vehicle telematics data of the first vehicle 110a to the external computing system 140.

The first communication protocol and the second communication protocol can be packet-based communication protocols. The sensor devices 120 can generate data packets according to either the first communication protocol or the second communication protocol. The second communication protocol can use smaller packets than the first communication protocol. In some implementations, a payload of data packets generated by the sensor devices 120 for use in the first communication protocol is larger than a payload of data packets generated by the sensor devices 120 for use in the second communication protocol. In some implementations, a payload of data packets generated by the sensor devices 120 for use in the first communication protocol is a same size as a payload of data packets generated by the sensor devices 120 for use in the second communication protocol.

The mobile devices 130 can use a third communication protocol to transmit vehicle telematics data (e.g., acceleration data) of the vehicles 110 to the external computing system 140. As discussed herein, the mobile devices 130 can each transmit telematics data of a corresponding vehicle (e.g., the first mobile device 130a corresponds to the first vehicle 110a) and/or other vehicles, where telematics data of other vehicles is transmitted between the sensor devices 120 on the low-frequency mesh network. The third communication protocol can be a cellular communication protocol. In some implementations, the mobile devices 130 use the third communication protocol to connect to the internet, by which the vehicle telematics data is transmitted to the external computing system 140.

In some implementations, the sensor devices 120 use the second communication protocol to transmit vehicle telematics data among themselves in response to the third communication protocol on a corresponding mobile device of the mobile devices 130 being unavailable. In this way, if the logical connection between a sensor device of the sensor devices 120 and the external computing system 140 is interrupted (either along the connection via the first communication protocol or the third communication protocol), the sensor device can use the second communication protocol to deliver telematics data to the external computing system 140. In some implementations, the sensor devices 120 can determine whether the corresponding mobile devices 130 have a connection with the external computing system 140 via the third communication protocol by determining that an expected response from the external computing system 140 has not been received. In an example, an acknowledgement from the external computing system 140 that telematics data originating at the first sensor device 120a and transmitted by the first mobile device 130a has been received at the external computing system 140 can indicate that the first mobile device 130a has a connection via the third communication protocol with the external computing system 140. In this example, a lack of the acknowledgement from the external computing system 140 after a predetermined amount of time can indicate that the first mobile device 130a does not have a connection via the third communication protocol with the external computing system 140.

In an example, the first sensor device 120a has a connection with the first mobile device 130a, but the first mobile device 130a does not have a connection with the external computing system 140. In this example, the first sensor device 120a, in response to the connection between the first mobile device 130a and the external computing system 140 being unavailable, transmits vehicle telematics data of the first vehicle 110a via the second communication protocol to the second sensor device 120b. If the second sensor device 120b has a connection with the second mobile device 130b and the second mobile device 130b has a connection with the external computing system 140, the second sensor device 120b transmits the vehicle telematics data of the first vehicle 110a to the second mobile device 130b using the first communication protocol so the second mobile device 130b can transmit the vehicle telematics data of the first vehicle 110a to the external computing system 140. If the second sensor device 120b does not have a connection with the second mobile device 130b or the second mobile device 130b does not have a connection with the external computing system 140, the second sensor device 120b transmits the vehicle telematics data of the first vehicle 110a to the third sensor device 120c using the second communication protocol and the third sensor device 120c transmits the vehicle telematics data of the first vehicle 110a to the third mobile device 130c using the first communication protocol so the third mobile device 130c can transmit the vehicle telematics data of the first vehicle 110a to the external computing system 140.

The external computing system 140 can analyze the vehicle telematics data (i.e., sensor data) of the vehicles 110 captured by the sensor devices 120 to determine characteristics of the vehicle telematics data. In some implementations, the external computing system 140 determines events in the vehicle telematics data. In some implementations, the external computing system 140 determines conditions in the vehicle telematics data corresponding to a plurality of predefined conditions. The external computing system 140 can determine the conditions based on determined events in the vehicle telematics data. The external computing system 140 can map events in the vehicle telematics data to the plurality of predefined conditions. In an example, the external computing system 140 can determine an event in the vehicle telematics data that indicates that a vehicle came to a stop with a deceleration above a predetermined threshold, corresponding to a “hard stop” condition. In an example, the external computing system 140 can determine an event in the vehicle telematics data that indicates that a vehicle accelerated from a stop with an acceleration above a predetermined threshold, corresponding to a “fast start” condition. In an example, the external computing system 140 can determine an event in the vehicle telematics data that indicates that the vehicle experience lateral movement above a predetermined threshold, corresponding to a “swerving” condition.

The external computing system 140 can execute one or more machine-learning models to determine the events and corresponding conditions in the vehicle telematics data. In some implementations, the external computing system 140 executes a machine-learning model using as input the vehicle telematics data to determine the events in the vehicle telematics data and the corresponding conditions. The machine-learning model can be any type of machine-learning model such as a neural network, a convolutional neural network (CNN), a recurrent neural network (RNN), a transformer network, a support vector machine, a decision tree, an ensemble tree, a generalized additive model (GAM), a naïve Bayes classifier, a k-Nearest neighbor (KNN) classifier, a discriminant analysis classifier, or any other type of machine-learning model. In some implementations, the external computing system 140 executes a first machine-learning model to determine a second machine-learning model to determine events in the vehicle telematics data. In an example, the external computing system 140 executes a CNN to determine features of the vehicle telematics data and identify a transformer network based on the features of the vehicle telematics data to determine events in the vehicle telematics data. The conditions determined using the vehicle telematics data can include driving behaviors and/or vehicle conditions such as hard braking, hard cornering, and flat and/or damaged tire. The vehicle conditions can be determined (e.g., by the sensor devices 120, the mobile devices 130, and/or the external computing system 140) based on vibrations of the vehicle, movement of the vehicle, and/or associated driving behaviors. The vehicle conditions and/or driving behaviors can be transmitted from the external computing system 140 to additional computing systems as driver behavior telematics or vehicle condition telematics. In this way, the determinations made by the external computing system 140 can be used in further analysis and/or processes.

In some embodiments, one or more of the sensor devices 120, the mobile devices 130, or the external computing system 140 execute one or more machine-learning models to determine the vehicle condition. In some implementations, the sensor devices 120 analyze the vehicle telematics data to determine one or more first preliminary characteristics of the vehicle telematics data and transmits the vehicle telematics data and the one or more first preliminary characteristics to the mobile devices 130. In an example, the sensor devices 120 each execute a sensor device machine-learning model using as input the vehicle telematics data to generate the one or more first preliminary characteristics of the vehicle telematics data. In some implementations, the mobile devices 130 analyze the vehicle telematics data and/or the one or more preliminary characteristics to determine one or more second preliminary characteristics of the vehicle telematics data and transmits the vehicle telematics data and the one or more second preliminary characteristics to the external computing system 140. In an example, the mobile devices 130 each execute a mobile device machine-learning model using as input the vehicle telematics data to generate the one or more second preliminary characteristics. In an example, the mobile devices 130 each execute the mobile device machine-learning model using as input the vehicle telematics data and the one or more first preliminary characteristics to generate the one or more second preliminary characteristics. In an example, the mobile devices 130 each execute the mobile device machine-learning model using as input the one or more first preliminary characteristics to generate the one or more second preliminary characteristics. In this way, the sensor devices 120 and/or the mobile devices 130 can determine preliminary characteristics of the vehicle telematics data. The external computing system 140 can use the determined preliminary characteristics in determining the events in the vehicle telematics data.

In some implementations, the sensor devices 120 transmit the vehicle telematics data captured by the sensor devices 120 to the mobile devices 130 which transmit the vehicle telematics data to the external computing system 140 which executes a machine-learning model to determine vehicle conditions (e.g., collision, driving behavior, flat tire, etc.). In some implementations, the sensor devices 120 transmit the vehicle telematics data captured by the sensor devices 120 to the mobile devices 130 which execute a preliminary machine-learning model to determine vehicle conditions and transmit the vehicle telematics data and the determinations to the external computing system 140 which executes a more powerful (e.g., more accurate) machine-learning model to determine whether the vehicle telematics data indicates the vehicle conditions. In some implementations, the sensor devices 120 capture the vehicle telematics data, execute a first machine-learning model (e.g., a machine-learning model having a lowest computational cost/complexity) to determine whether the vehicle telematics data indicates vehicle conditions, and transmits the vehicle telematics data and their determinations to the mobile devices 130 which execute a second, intermediate (e.g., intermediate power and/or accuracy and/or having a medium computational cost/complexity) machine-learning model to determine whether the vehicle telematics data indicates the vehicle conditions and transmits the vehicle telematics data and their determinations to the external computing system 140 which executes a final (e.g., most accurate, most powerful and/or having a highest computational cost/complexity) machine-learning model to determine whether the vehicle telematics data indicates the vehicle conditions. In this way, different combinations of machine-learning models executed by the sensor device s, the mobile devices 130, and the external computing system 140 can cooperate to provide an accurate determination of whether the vehicle telematics data indicates the vehicle conditions.

In some implementations, the sensor devices 120, the mobile devices 130, and/or the external computing system 140 continuously execute their respective machine-learning models. In some implementations, each of the sensor devices 120, the mobile devices 130, and/or the external computing system 140 executes a process or machine-learning model to determine whether to execute their respective machine-learning models to detect flat tires or tire damage. In an example, the external computing system 140 executes an orchestrator machine-learning model using as input the vehicle telematics data to determine further analysis to be performed on the vehicle telematics data, including executing a machine-learning model trained to detect specific vehicle conditions. In some implementations, the mobile devices 130 and/or the external computing system 140 execute their respective machine-learning models for detecting vehicle conditions in response to a determination by the sensor devices 120 or the mobile devices 130, respectively, that the vehicle telematics data indicates the vehicle conditions.

The external computing system 140 can associate vehicle telematics data (e.g., acceleration data) of the vehicles 110 with identifiers of the vehicles 110 in a database. In some implementations, the vehicle telematics data includes identifiers of the vehicles 110 such that the external computing system 140 can associate telematics data with the correct vehicle of the vehicles 110 independent of which mobile device of the mobile devices 130 transmits the vehicle telematics data to the external computing system 140. In some implementations, the vehicle telematics data includes identifiers of the sensor devices 120 and/or the mobile devices 130, where the identifiers of the sensor devices 120 and/or the mobile devices 130 are associated with the identifiers of the vehicles 110. In an example, the external computing system 140 receives telematics data including an identifier of the first sensor device 120a and queries a first database to identify an identifier of the first vehicle 110a associated with the identifier of the first sensor device 120a. In this example, the external computing system 140 associates the identifier of the first vehicle 110a with the vehicle telematics data, events, and/or conditions in a second database.

In some implementations, the external computing system 140 determines that the low-frequency mesh network of the sensor devices 120 is being used to transmit telematics data. In an example, the external computing system 140 can determine that the low-frequency mesh network is being used based on receiving telematics data of the first vehicle 110a from the second mobile device 130b or the third mobile device 130c. In response to determining that the low-frequency mesh network is being used, the external computing system 140 can transmit a message to one or more mobile devices of the mobile devices 130 regarding the connection between the one or more mobile devices and one or more corresponding sensor devices of the sensor devices 120. In an example, the external computing system 140 sends a message to the first mobile device 130a in response to determining that the first sensor device 120a is using the low-frequency mesh network to deliver telematics data of the first vehicle 110a to the external computing system 140. In this example, the message causes an application running on the first mobile device 130a to attempt to establish a connection with the first sensor device 120a using the first communication protocol or causes the first mobile device 130a to display a notification prompting a user to reconnect the first mobile device 130a to the first sensor device 120a (e.g., tun on BLUETOOTH).

Use of the low-frequency mesh network may be an opt-in option for delivering telematics data to the external computing system 140. In some implementations, the sensor devices 120 each store a configuration reflecting user preferences, where the configuration defines whether the sensor devices 120 will use the low-frequency mesh network. In some implementations, the configuration defines conditions under which the low-frequency mesh network can be used. In an example, the configuration can indicate that the low-frequency mesh network can be used in the event of an accident, such that if a connection between the first sensor device 120a and the first mobile device 130a is lost during an accident, the first sensor device 120a can use the low-frequency mesh network to deliver telematics data including an alert regarding the accident to the external computing system 140. In an example, the configuration can indicate that the low-frequency mesh network can be used only if a strength of a cellular connection between the first mobile device 130a and the external computing system 140 is below a predetermined threshold. In an example, the configuration can indicate that the low-frequency mesh network can be used only to transmit messages from the first sensor device 120a, but that the first mobile device 130a cannot be used to transmit telematics data of other vehicles to the external computing system 140. The configuration can define various triggers and conditions for use of the low-frequency mesh network, all of which are contemplated within the scope of the present disclosure.

It should be appreciated that the various architectures illustrated and described herein are provided for purposes of illustration only, and in various implementations, one or more of a variety of different architectures may be utilized. In some implementations, fewer components than illustrated in FIG. 1 may be utilized. For example, the sensor devices 120 and/or the mobile devices 130 may perform some or all of the processing functions described herein by itself or in combination with one another without utilizing one or more of the other devices (e.g., the external computing system 140). In some such implementations, the sensor devices 120 may perform the processing to detect vehicle conditions and may transmit an indication of the vehicle conditions to the mobile devices 130. In some implementations, the external computing system 140 may be a single external computing system or other computing device while, in other implementations, the external computing system 140 may be implemented using a distributed or cloud computing environment using multiple computing devices. All such implementations are contemplated within the scope of the present disclosure.

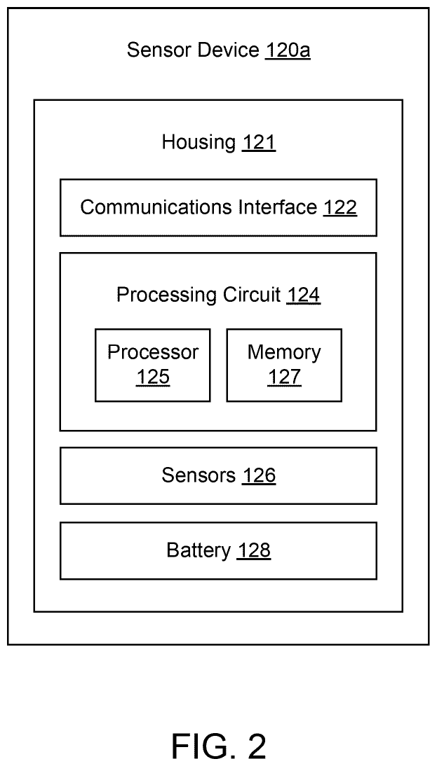

FIG. 2 illustrates details of the first sensor device 120a of FIG. 1. The first sensor device 120a includes a housing 121. The housing 121 can be separate from and distinct from the first vehicle 110a. The housing 121 can be structured to be coupled to a vehicle. The housing 121 can be coupled to the first vehicle 110a to allow the first sensor device 120a to capture vehicle telematics data of the first vehicle 110a. The housing 121 encloses a communications interface 122, a processing circuit 124, sensors 126, and a battery 128.

The first sensor device 120a can use the communications interface 122 to communicate with the first mobile device 130a and the other sensor devices of the sensor devices 120 (i.e., the second sensor device 120b and the third sensor device 120c. The communications interface 122 can include one or more antenna for communicating using the first communication protocol and the second communication protocol. In some implementations, the communications interface 122 includes a first antenna for communicating using the first communication protocol and a second antenna for communicating using the second communication protocol. In some implementations, the communications interface 122 includes a single antenna for communicating using the first and second communication protocols. In some implementations, the communications interface 122 includes multiple antennae for communicating using the first communication protocol and/or multiple antennae for communicating using the second communication protocol.

The processing circuit 124 receives telematics data from the sensors 126 to log and/or analyze the vehicle telematics data. The processing circuit 124 includes a processor 125 and a memory 127. The processor 125 can receive the vehicle telematics data from the sensors 126 and correlate the vehicle telematics data. In an example, the processor 125 receives time series acceleration data from three accelerometers capturing acceleration data along different axes and correlates the time series acceleration data into three-dimensional acceleration data. In an example, the processor 125 receives time series acceleration data from a multi-axis accelerometer capturing acceleration data along three different axes. The processor 125 can log (i.e., store) the vehicle telematics data in the memory 127. The processor 125 can execute lower-power processes to determine whether to execute higher-power processes such as execution of a machine-learning model.

The sensors 126 can include multiple different types of sensors including accelerometers, gyroscopes, barometers, sound sensors, and other sensors for capturing telematics data that can be used to determine vehicle conditions and/or for capturing telematics data that can be used to determine driving behavior.

The sensors 126, the processing circuit 124, and the communications interface 122 draw power from the battery 128. By drawing power from the battery 128, the first sensor device 120a can operate independent of the first vehicle 110a and a state of the first vehicle 110a, allowing the first sensor device 120a to be coupled to any vehicle.

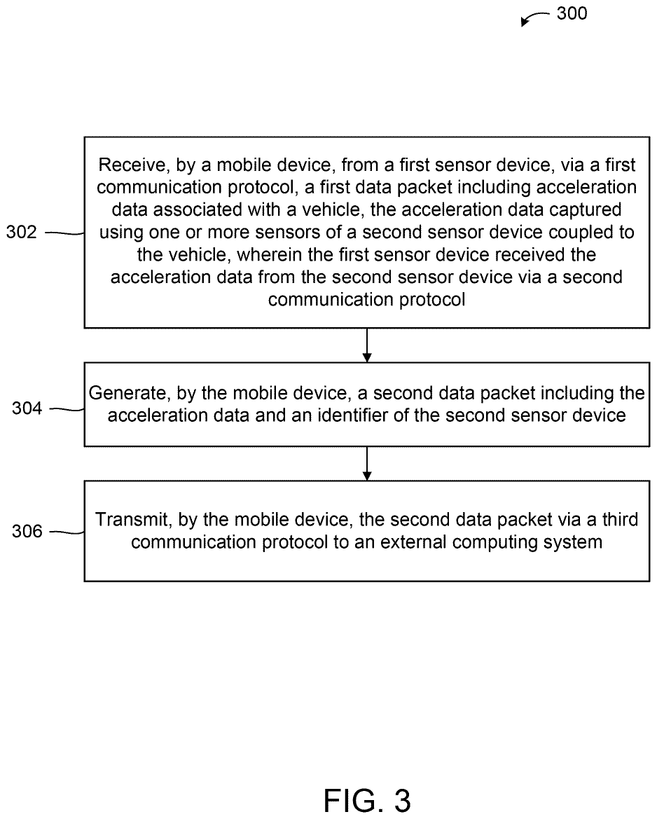

FIG. 3 is a flow chart illustrating operations of an example method 300 for transmitting vehicle telematics data via a low-frequency mesh network. The method 300 can include more, fewer, or different operations than shown. The operations can be performed in the order shown, in another order, or concurrently. The method 300 can be performed by one or more components in the system 100 of FIG. 1, such as one or more of the mobile devices 130. The method 300 can be performed by a computing device including one or more processors and one or more non-transitory, computer-readable media that, when executed by the one or more processors, cause the one or more processors to perform the operations of the method 300.

At operation 302, a mobile device receives, from a first sensor device, via a first communication protocol, a first data packet including vehicle telematics data associated with a vehicle, the vehicle telematics data captured using one or more sensors of a second sensor device coupled to the vehicle, where the first sensor device received the vehicle telematics data from the second sensor device via a second communication protocol. In some implementations, the first sensor device and the second sensor device are part of a low-frequency mesh network using the second communication protocol. In some implementations, the first data packet includes an identifier of the second sensor device. In some implementations, the first data packet includes an identifier of an identifier of the vehicle. The first sensor device can be coupled to a corresponding vehicle. In an example, the mobile device is a mobile device of a user driving the corresponding vehicle.

The first sensor device includes a housing enclosing one or more accelerometers, where the housing is separate from and structured to be coupled to a vehicle. The second sensor device includes a housing enclosing one or more accelerometers, where the housing is separate from and structured to be coupled to a vehicle, where the housing of the second sensor device is coupled to the vehicle associated with the vehicle telematics data. The first and second sensor devices can be substantially identical to each other and/or interchangeable.

In some implementations, the first sensor device received the second sensor device in an initial data packet according the second communication protocol. In some implementations, the initial data packet is the same as the first data packet. In some implementations, a payload of the initial data packet is the same as a payload of the first data packet.

In some implementations, the first sensor device received the vehicle telematics data from the second sensor device via a third sensor device. The first, second, and third sensor device can be part of a mesh network, where the vehicle telematics data is transmitted through the mesh network until the vehicle telematics data reaches the first sensor device. In an example, the vehicle telematics data originated at the second sensor device and was passed through the mesh network by six sensor devices including the third sensor device to the first sensor device. The first sensor device may be final sensor device in the mesh network to receive the vehicle telematics data, as the first sensor device is connected to the mobile device such that the vehicle telematics data can be transmitted by the mobile device to an external computing system (e.g., server). The vehicle telematics data may be passed through the mesh network until the vehicle telematics data is received by a sensor device having a connection to a mobile device.

The first communication protocol can be a high-frequency, short-range wireless protocol for communications between the first sensor device and the mobile device. The second communication protocol can be a low-frequency, long-range wireless protocol for communications between the first sensor device and the second sensor device, or for establishing a low-frequency mesh network including the first sensor device and the second sensor device. The first communication protocol can use frequencies between 2.402 GHz and 2.48 GHz and the second communication protocol can use frequencies less than 1 GHz. In an example, the first communication protocol is BLUETOOTH and the second communication protocol is a long range wide area (LORAWAN) protocol.

At operation 304, the mobile device generates a second data packet including the vehicle telematics data and the identifier of the second sensor device. In some implementations, the second data packet is the same as the first data packet, and generating the second data packet includes routing the first data packet. In some implementations, a payload of the second data packet is the same as a payload of the first data packet, and generating the second data packet includes converting the first data packet into the second data packet according to a third communication protocol.

At operation 306, the mobile device transmits the second data packet via the third communication protocol to the external computing system. The third communication protocol may be a cellular communication protocol. In some implementations, the mobile device transmits the second data packet via the third communication protocol using a cellular network that connects to the internet to deliver the second data packet, or the contents of the second data packet, to the external computing system. In some implementations, the method 300 includes determining, by the external computing system, using the vehicle telematics data associated with the vehicle, a vehicle condition of a plurality of vehicle conditions. In some implementations, the method 300 includes associating, by the external computing system, in a database, the vehicle telematics data and/or the determined vehicle condition, with the vehicle.

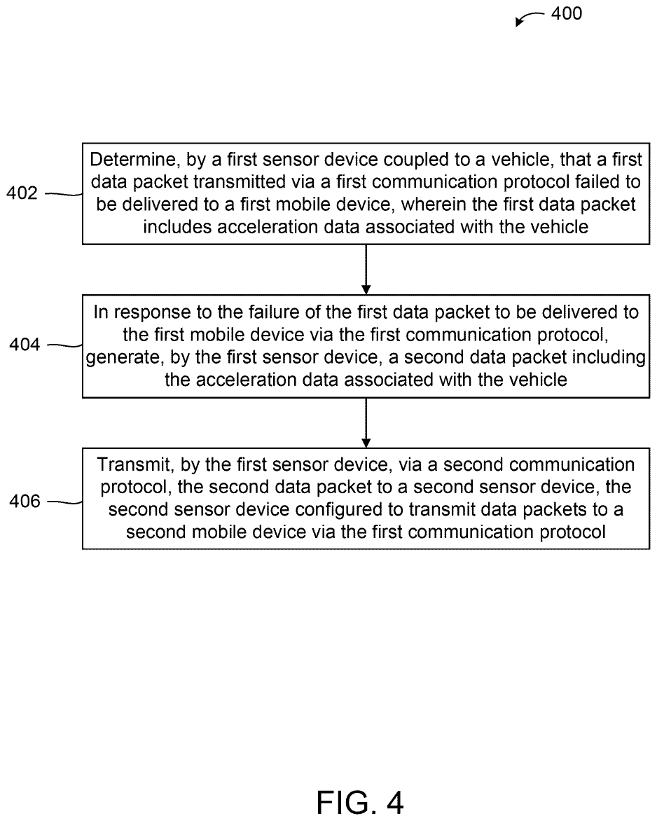

FIG. 4 is a flow chart illustrating operations of an example method 400 for transmitting vehicle telematics data via a low-frequency mesh network. The method 400 can include more, fewer, or different operations than shown. The operations can be performed in the order shown, in another order, or concurrently. The method 400 can be performed by one or more components of the system 100 of FIG. 1, such as one or more of the sensor devices 120. The method 400 can be performed by a computing device including one or more processors and one or more non-transitory, computer-readable media that, when executed by the one or more processors, cause the one or more processors to perform the operations of the method 400.

At operation 402, a first sensor device coupled to a vehicle determines that a first data packet transmitted via a first communication protocol failed to be delivered to a first mobile device, where the first data packet includes vehicle telematics data associated with the vehicle. The first sensor device can determine that the first data packet failed to be delivered to the first mobile device based on not receiving an acknowledgement of the first data packet within a predetermined amount of time. The first sensor device can attempt transmission of the first data packet, track how long since the attempted transmission, and determine that the predetermined amount of time has elapsed since the attempted transmission of the data packet without receiving the acknowledgement from the first mobile device. The first communication protocol can be a high-frequency, low-range wireless protocol. The first communication protocol can be the first communication protocol described in the method 300 of FIG. 3.

At operation 404, in response to the failure of the first data packet to be delivered to the first mobile device via the first communication protocol, the first sensor device generates a second data packet including the vehicle telematics data associated with the vehicle. The second data packet can be generated according to a second communication protocol. The second communication protocol can be a low-frequency, high-range wireless protocol. The second communication protocol can be a long range wide area network (LORAWAN) communication protocol. In some implementations, the second communication protocol uses a frequency less than 1 GHz. The second communication protocol can be the second communication protocol described in the method 300 of FIG. 3.

At operation 406, the first sensor device transmits the second data packet via the second communication protocol to a second sensor device, where the second sensor device is configured to transmit data packets to a second mobile device via the first communication protocol. The second sensor device can have a connection with the second mobile device such that the second sensor device transmits the contents of the second data packet to the second mobile device via the first communication protocol such that the second mobile device can transmit the contents of the second data packet to an external computing system via a third communication protocol, as described herein. The first mobile device and the second mobile device include instructions to transmit data to the external computing system via the third communication protocol. In some implementations, the sensor data captured by the first sensor device would have been transmitted to the external computing system by the first mobile device if a connection existed between the first sensor device and the first mobile device (i.e., if the first data packet had been successfully transmitted from the first sensor device to the first mobile device).

### Non-Limiting Example

In an example, a sensor device is attached on an interior surface of a windshield of a vehicle. The sensor device can connect to a mobile device of a driver of the vehicle to transmit vehicle telematics data to the mobile device using BLUETOOTH. The mobile device can transmit the vehicle telematics data to an external computing system using a cellular connection. The sensor device can determine that the vehicle telematics data is not reaching the external computing system, either due to failure of the BLUETOOTH connection or failure of the cellular connection. The sensor device can send the vehicle telematics data through a LORAWAN mesh network formed by multiple sensor devices until the vehicle telematics data reaches a connected sensor device that has a connection to the external computing system via a connected mobile device. The connected sensor device transmits the vehicle telematics data via BLUETOOTH to the connected mobile device which transmits the vehicle telematics data to the external computing system using its cellular connection. The external computing system associates the vehicle telematics data with the vehicle in a database based on an identifier of the sensor device received with the vehicle telematics data.

### Additional Considerations

As discussed herein, “vehicle telematics data” refers to sensor data transmitted by sensor devices and/or mobile devices to an external computing system, such as geolocation, velocity, acceleration/deceleration, airbag deployment, etc. The vehicle telematics data can be used, as discussed herein, to identify driving behaviors and/or vehicle conditions, which can be transmitted from the external computing system to additional computing systems as driving behavior telematics and/or vehicle condition telematics. The driving behavior telematics and/or the vehicle condition telematics can include determinations made by the external computing system using the vehicle telematics data (i.e., sensor data), but not including the vehicle telematics data itself.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In some embodiments, a computer program is provided, and the program is embodied on a computer readable medium. In some embodiments, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The construction and arrangement of the systems and methods as shown in the various example embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied, and the nature or number of discrete elements or positions can be altered or varied. Accordingly, all such modifications are intended to be included within the scope of the present disclosure. The order or sequence of any process or method operations, actions, or functionality may be varied or re-sequenced according to alternative embodiments. Other substitutions, modifications, changes, and omissions can be made in the design, operating conditions, and arrangement of the example embodiments without departing from the scope of the present disclosure.

As used herein, an element or operation recited in the singular and proceeded with the word “a” or “an” should be understood as not excluding plural elements or operations, unless such exclusion is explicitly recited. Furthermore, references to “exemplary embodiment,” “one embodiment,” or “some embodiment” of the present disclosure are not intended to be interpreted as excluding the existence of additional embodiments that also incorporate the recited features.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The patent claims at the end of this document are not intended to be construed under 35 U.S.C. § 112(f) unless traditional means-plus-function language is expressly recited, such as “means for” or “step for” language being expressly recited in the claim(s).

Although the Figures show a specific order of method operations, actions, or functionality, the order of such may differ from what is depicted. Also, two or more operations, actions, or functionalities may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection operations or actions, processing operations or actions, comparison operations or actions, and decision operations or actions.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The term “coupled” and variations thereof, as used herein, means the joining of two members directly or indirectly to one another. Such joining may be stationary (e.g., permanent, or fixed) or moveable (e.g., removable, or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

In various implementations, the functionality and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular industrial environment or portion of an industrial environment. Additionally or alternatively, the operations may be performed by a combination of one or more central or offsite computing devices/servers and one or more local controllers/computing devices. All such implementations are contemplated within the scope of the present disclosure.

Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. A system comprising one or more non-transitory, computer-readable media including instructions which, when executed by one or more processors, cause the one or more processors to:
receive, via a first communication protocol, from a first sensor device, a first data packet including vehicle telematics data associated with a vehicle, the vehicle telematics data captured using one or more sensors of a second sensor device coupled to the vehicle, wherein the first sensor device received the vehicle telematics data from the second sensor device via a second communication protocol that uses a frequency less than 1 GHz;
generate a second data packet including the vehicle telematics data and an identifier of the second sensor device; and
transmit the second data packet via a third communication protocol to an external computing system.

2. The system of claim 1, wherein the first sensor device includes a housing enclosing one or more accelerometers, wherein the housing is separate from and structured to be coupled to a vehicle.

3. The system of claim 1, wherein the first sensor device is substantially identical to the second sensor device, and wherein the first sensor device is structured to be coupled to a vehicle.

4. The system of claim 1, wherein the second communication protocol has a range of over one mile.

5. The system of claim 1, wherein the second communication protocol comprises a long range wide area network protocol.

6. The system of claim 1, further comprising the external computing system, wherein the external computing system executes instructions to associate, in a database, the vehicle telematics data with the vehicle.

7. The system of claim 1, further comprising the external computing system, wherein the external computing system determines, using the vehicle telematics data associated with the vehicle, a vehicle condition of a plurality of predefined vehicle conditions.

8. The system of claim 1, wherein the first sensor device received the vehicle telematics data from the second sensor device via a third sensor device.

9. A method comprising:
receiving, by a mobile device, from a first sensor device, via a first communication protocol, a first data packet including vehicle telematics data associated with a vehicle, the vehicle telematics data captured using one or more sensors of a second sensor device coupled to the vehicle, wherein the first sensor device received the vehicle telematics data from the second sensor device via a second communication protocol that has a range of over one mile;
generating, by the mobile device, a second data packet including the vehicle telematics data and an identifier of the second sensor device; and
transmitting, by the mobile device, the second data packet via a third communication protocol to an external computing system.

10. The method of claim 9, wherein the first sensor device includes a housing enclosing one or more accelerometers, wherein the housing is separate from and structured to be coupled to a vehicle.

11. The method of claim 9, wherein the first sensor device is substantially identical to the second sensor device, and wherein the first sensor device is structured to be coupled to a vehicle.

12. The method of claim 9, wherein the second communication protocol uses a frequency less than 1 GHz.

13. The method of claim 9, wherein the second communication protocol comprises a long range wide area network protocol.

14. The method of claim 9, further comprising associating in a database, by the external computing system, the vehicle telematics data with the vehicle.

15. The method of claim 9, further comprising determining, by the external computing system, using the vehicle telematics data associated with the vehicle, a vehicle condition of a plurality of predefined vehicle conditions.

16. The method of claim 9, wherein the first sensor device received the vehicle telematics data from the second sensor device via a third sensor device.

17. A method comprising:
determining, by a first sensor device coupled to a vehicle, that a first data packet transmitted via a first communication protocol failed to be delivered to a first mobile device, wherein the first data packet includes vehicle telematics data associated with the vehicle;
in response to the failure of the first data packet to be delivered to the first mobile device via the first communication protocol, generating, by the first sensor device, a second data packet including the vehicle telematics data associated with the vehicle; and
transmitting, by the first sensor device, via a second communication protocol, the second data packet to a second sensor device, wherein the second communication protocol uses a frequency less than 1 GHz with a range of over one mile, and wherein the second sensor device is configured to transmit data packets to a second mobile device via the first communication protocol.

18. The method of claim 17, wherein determining, by the first sensor device, that the first data packet transmitted via a first communication protocol failed to be delivered to the first mobile device includes determining that a predetermined amount of time has elapsed since attempted transmission of the data packet without receiving an acknowledgement from the first mobile device.

19. The method of claim 17, wherein the first mobile device and the second mobile device include instructions to transmit data to an external computing system via a third communication protocol.

20. The method of claim 17, wherein the second communication protocol comprises a long range wide area network protocol.
